(19) United States
(12) Patent Application Publication
(10) Pub. No.: US 2024/0161146 A1
(43) Pub. Date: May 16, 2024

(54) SYSTEM TO SELECT IN-STORE OR E-COMMERCE CHANNELS FOR OPTIMIZED DELIVERY OF CREATIVE MEDIA TO CONSUMERS

(71) Applicant: Catalina Marketing Corporation, St. Petersburg, FL (US)

(72) Inventors: Zubin Singh, San Jose, CA (US); Ryan Monahan, Orange, CA (US); Kirk Dikun, Tampa, FL (US); Julie Valdez, St. Petersburg, FL (US); Todd Schramek, St. Petersburg, FL (US); Ronald P. Menich, Marietta, GA (US); Tony Mou, St. Petersburg, FL (US)

(21) Appl. No.: 18/552,094

(22) PCT Filed: Mar. 25, 2022
(86) PCT No.: PCT/US22/21892

§ 371 Date: Sep. 22, 2023

Related U.S. Application Data
(60) Provisional application No. 63/166,774, filed on Mar. 26, 2021.

(51) Int. Cl. G06Q 30/0207; G06Q 30/0203; G06Q 30/0204; G06Q 30/0226; G06Q 30/0251

(52) U.S. Cl. CPC G06Q 30/0224; G06Q 30/0203; G06Q 30/0204; G06Q 30/0233; G06Q 30/0267

(57) ABSTRACT

A method to select in-store or e-commerce channels for optimized delivery of creative media to consumers includes selecting, based on a prior purchasing behavior for a consumer, a targeted offer, wherein the targeted offer includes at least one of a coupon, a discount, or an advertisement for a retail product. The method also includes selecting a channel for the consumer to redeem the targeted offer, wherein the channel for the consumer to redeem the targeted offer includes one of an in-store redemption of the targeted offer or an online redemption in a shopping basket, providing the targeted offer for display in a client device used by the consumer, and indicating, in the display, the channel for the consumer to redeem the targeted offer. A non-transitory, computer-readable medium storing instructions and a system to perform the above method are also provided.

### CROSS-REFERENCE TO RELATED APPLICATIONS

The present disclosure is related and claims priority under the PCT to U.S. Prov. Pat. Appln. No. 63/166,774, entitled SYSTEM TO SELECT IN-STORE OR E-COMMERCE CHANNELS FOR OPTIMIZED DELIVERY OF CREATIVE MEDIA TO CONSUMERS, to Zubin SINGH et al., filed on Mar. 26, 2021, the contents of which are hereby incorporated by reference, in their entirety, for all purposes.

### BACKGROUND

### Field

The present disclosure is related to providing targeted offers to consumers via mobile devices, and selecting a redemption channel for the targeted offer that the consumer is more likely to use. More specifically, the present disclosure is directed to providing an in-store or an online redemption channel for a targeted offer to a consumer based on consumer habits and other environmental factors.

### Brief Background Description

In the existing world of digital promotions, many applications and modalities exist that enable a consumer to access product offers, value added offers, coupons, and deals from different retailers and product manufacturers via a mobile device application. However, it often happens that the offer received by the consumer is redeemable in a format that may not be convenient or desirable for the user given a certain combination of circumstances. Accordingly, the consumer may simply skip the offer, thus incurring in a loss of advertisement efficiency.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates a system for providing optimized consumer segments, according to some embodiments.

FIG. 2 illustrates details of exemplary devices used in one embodiment of the architecture of FIG. 1, according to some embodiments.

FIG. 3 illustrates an online channel for redeeming an incentive, according to some embodiments.

FIG. 4 illustrates an in-store channel for redeeming an incentive, according to some embodiments.

FIG. 5 is a flow chart illustrating steps in a method for selecting a channel for a user to redeem an offer in a creative media provided to the user, according to some embodiments.

FIG. 6 is a flow chart illustrating steps in a method for generating a creative media including a personalized offer for a user, according to some embodiments.

FIG. 7 is a block diagram illustrating an example computer system with which the client and server of FIGS. 1 and 2 and the methods of FIGS. 5 and 6 can be implemented, according to some embodiments.

In the figures, elements and steps denoted by the same or similar reference numerals are associated with the same or similar elements and steps, unless indicated otherwise.

### SUMMARY

In a first embodiment, a computer-implemented method includes selecting, based on a prior purchasing behavior for a consumer, a digital payload, wherein the digital payload comprises at least one of a coupon, a discount, or an advertisement for a retail product, selecting a channel for the consumer to validate the digital payload, wherein the channel for the consumer to validate the digital payload comprises one of an onsite validation of the digital payload or an online validation in a shopping basket, providing the digital payload for display in a client device used by the consumer, and indicating, in the display, the channel for the consumer to redeem the digital payload.

In a second embodiment, a system includes one or more processors configured to execute multiple instructions, and a memory storing the instructions that cause the one or more processors to cause the system to perform operations. The operations include to: select, based on a prior purchasing behavior for a consumer, a digital payload, wherein the digital payload comprises at least one of a coupon, a discount, or an advertisement for a retail product, select a channel for the consumer to validate the digital payload, wherein the channel for the consumer to validate the digital payload comprises one of an onsite validation of the digital payload or an online validation in a shopping basket, provide the digital payload for display in a client device used by the consumer, and indicate, in the display, the channel for the consumer to redeem the digital payload.

In a third embodiment, a computer-implemented method includes providing, to a client device with a consumer, a digital payload including a coupon or a discount for a retail product or service, identifying a location of the consumer based on a location of the client device, upon the consumer activating the digital payload, providing instructions to the consumer for redeeming the coupon or the discount at a point of sale when the location of the consumer is within a store having the retail product for sale, and activating a payment application in the client device for the consumer.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

When consumers receive advertisements, product offers, and other value added certificates or rewards via a mobile application, an important aspect in determining whether the consumer will redeem the offer or respond to the advertisement is the channel for the consumer to redeem the offer or reward. For example, when the consumer is an online shopper, it is unlikely the consumer will go to the store to redeem an in-store offer or reward. Likewise, if the consumer is walking through the aisles in a retailer store, it is unlikely that the consumer will load an offer or reward to an online shopping cart for a later purchase or redemption.

Embodiments as disclosed herein provide tools and techniques to serve an advertisement, a digital incentive, an offer, a discount, or a deal in the most convenient form for redemption by a consumer. To evaluate the most convenient form for redemption, or the most likely form that will result in a consumer redemption, a system consistent with the present disclosure may include machine learning and artificial intelligence algorithms that use psychographic factors, technographic factors, purchase history data, and updated environmental data to assess which of one or more options for redemption is more likely to be used by the consumer at a given point in time and space.

### General Overview

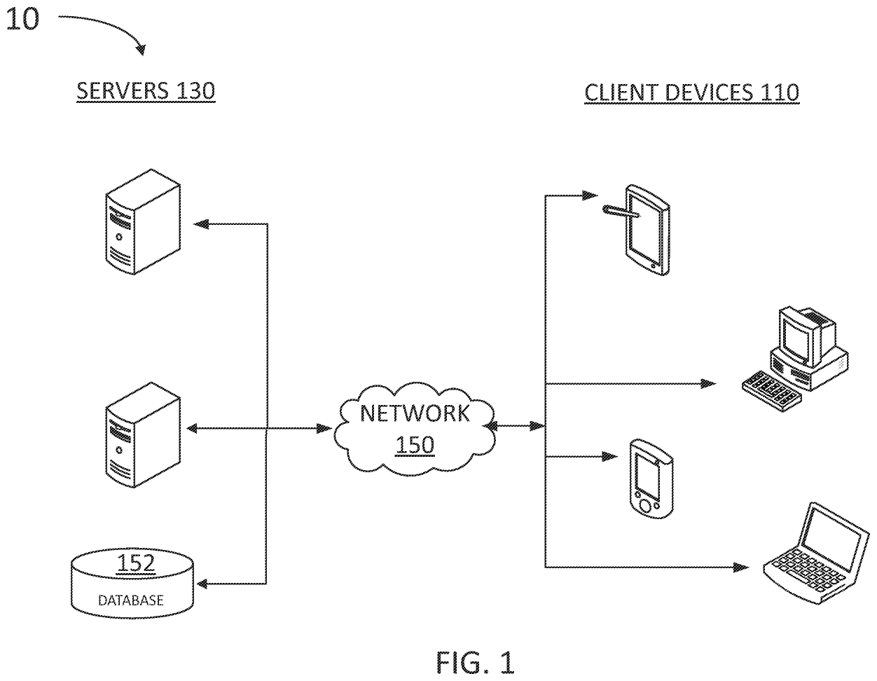

FIG. 1 illustrates an architecture in a system 10 for providing optimized advertisement payloads including offers, discounts, and value-added certificates, according to some embodiments. System 10 includes servers 130, client devices 110, and at least one database 152, communicatively coupled with each other through a network 150. Servers 130 and client devices 110 have a memory, including instructions which, when executed by a processor, cause servers 130 and client devices 110 to perform at least some of the steps in methods as disclosed herein. In some embodiments, system 10 is configured to present personalized digital promotions, coupons and value-added offers to a consumer, who may be the user of one or more client devices 110. A personalized digital promotion may be generated by server 130 from a purchase history of the consumer, which may be stored in a history log in a memory of the server or in database 152. In some embodiments, a user of one of client devices 110 is an advertising agent accessing a creative media engine in a server 130 to design and execute an advertising campaign on behalf of a brand manufacturer, or a retail store. In some embodiments, the user of one of client devices 110 may include the brand manufacturer or the retail store itself.

Servers 130 and database 152 may include any device having an appropriate processor, memory, and communications capability for hosting a history log of purchasing data, an advertisement database, and a creative media engine. The creative media engine may be accessible by various client devices 110 over network 150. In some embodiments, servers 130 may include a dynamic rendering server, a publisher, or a supply side platform (SSP) server, and a demand side platform (DSP) server. Client devices 110 may include, for example, desktop computers, mobile computers, tablet computers (e.g., including e-book readers), mobile devices (e.g., a smartphone or PDA), or any other devices having appropriate processor, memory, and communications capabilities for accessing the creative media engine and the history log on one or more of servers 130. Network 150 may include, for example, any one or more of a local area network (LAN), a wide area network (WAN), the Internet, and the like. Further, the network can include, but is not limited to, any one or more of the following network topologies, including a bus network, a star network, a ring network, a mesh network, a star-bus network, tree or hierarchical network, and the like.

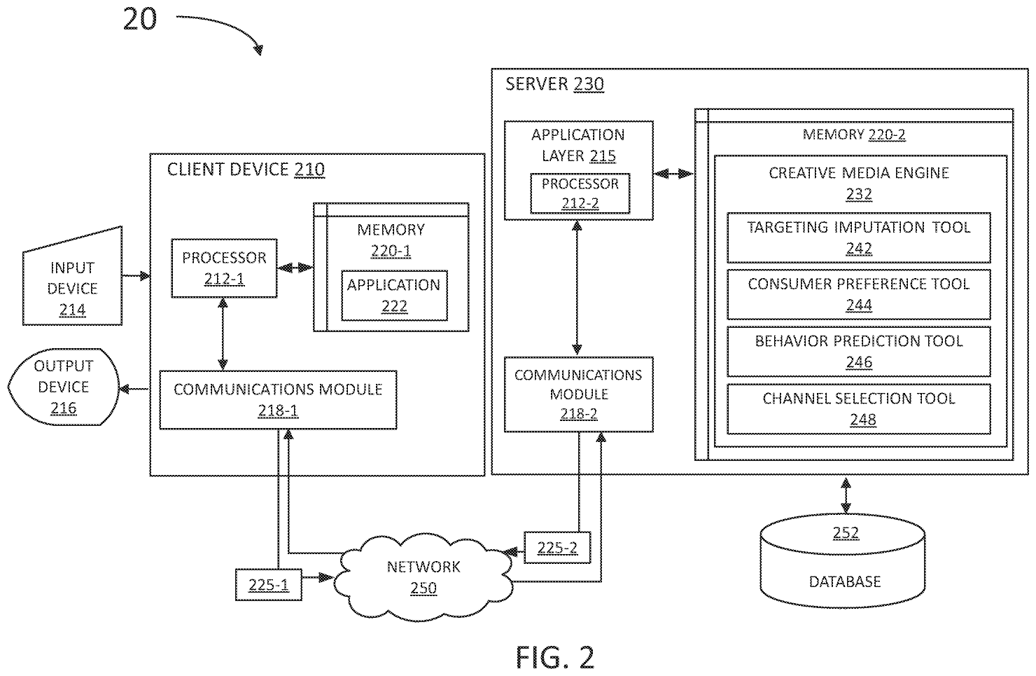

FIG. 2 illustrates details of exemplary devices used in one embodiment of a system 20, according to some embodiments. A client device 210, a server 230, and a database 252 are communicatively coupled over a network 250 (cf. client devices 110, servers 130, database 152, and network 150) via respective communications modules 218-1 and 218-2 (hereinafter, collectively referred to as “communication modules 218”). Communications modules 218 are configured to interface with network 250 to send and receive information, such as data, requests, responses, and commands to other devices on network 250. In some embodiments, communications modules 218 can be, for example, modems or Ethernet cards. Client device 210 may be coupled with an input device 214 and with an output device 216. Input device 214 may include a keyboard, a mouse, a pointer, or even a touchscreen display that a user (e.g., a consumer) may utilize to interact with the client device. Likewise, output device 216 may include a display and a speaker with which the user may retrieve results from client device 210.

Client device 210 may also include a processor 212-1 configured to execute instructions stored in a memory 220-1, and to cause client device 210 to perform at least some of the steps in methods consistent with the present disclosure. Memory 220-1 may further include an application 222 storing specific instructions which, when executed by processor 212-1, provide a data payload 225-1 to server 230, and cause a data payload 225-2 from server 230 to be displayed for the user of client device 210. Data payloads 225-1 and 225-2 will be referred to, hereinafter, as “data payloads 225.” Data payload 225-2 may include an advertisement payload to be displayed for the consumer, or a coupon or personalized offer that the consumer may redeem using a selected channel. In some embodiments, the selected channel may be an online coupon for a consumer that is not likely to leave their home. In some embodiments, the selected channel may be a printable coupon at a point-of-sale (POS) in a retail store where the consumer is located. Application 222 may be installed by and perform scripts and other routines provided through an application layer 215 in server 230. Application layer 215 includes a processor 212-2 configured to execute instructions stored in a memory 220-2. In some embodiments, a consumer, having a frequent shopper identification or not, may download application 222 from an “online store” of a retailer, or a brand manufacturer. The advertisement payload may include advertising messages or multiple digital promotions, or coupons presented to the consumer by the server, and the consumer may store at least some of the digital promotions or coupons from the advertisement payload in memory 220-1. In some embodiments, application 222 includes instructions which, when executed by processor 212-1, cause a display in output device 216 to display a portal of a creative media engine 232 hosted by server 230. Accordingly, application 222 may include instructions, which when executed by processor 212-1, cause an output device 216 to display a personalized offer for the consumer according to an advertisement campaign or a prediction that the consumer will purchase more related or like products. Moreover, in some embodiments, application 222 may include instructions which, when executed by processor 212-1, cause a POS device to print the personalized offer, or store it in database 252 for online redemption.

Server 230 includes a memory 220-2, a processor 212-2, and communications module 218-2. Processor 212-2 is configured to execute instructions, such as instructions physically coded into processor 212-2, instructions received from software in memory 220-2, or a combination of both. Memory 220-2 includes a creative media engine 232 configured to prepare a digital payload 225-2 for the consumer with client device 210. In some embodiments, creative media engine 232 selects personalized product offers, coupons, and the like, based on consumer preferences, a past purchasing history of the consumer, and a likelihood that the consumer will increase their spending on certain products or stores. Creative media engine 232 is configured to select a channel for redemption of the personalized offer to the consumer based on a consumer location and network configuration or connectivity of client device 210 used by the consumer. In this regard, client device 210 may be a smartphone or other mobile device used by a consumer browsing through the shelves in a retail store. In some embodiments, client device 210 may include a computer or any other network connected device at the point of sale (POS) in a retail store. In yet other embodiments, client device 210 may include a server or centralized computer in a retail store server, providing real-time purchasing data to server 230 hosting creative media engine 232. Creative media engine 232 may include a targeting imputation tool 242, a consumer preference tool 244, a behavior prediction tool 246, and a channel selection tool 248.

Targeting imputation tool 242 imputes consumer attributes used for selecting targeted offers to the consumer, the attributes gleaned from a purchasing history of the consumer. Consumer preference tool 244 identifies a consumer preference for a brand product or item. In some embodiments, consumer preference tool 244 also determines consumer sensitivity to marketing impulses. For example, consumer preference tool 244 may determine a change in consumer preference based on the pricing of a product or item. Accordingly, creative media engine 232 may select an offer or promotion for digital payload 225-2 that lowers a price value of a potential product based on an expected change in consumer preference. Behavior prediction tool 246 determines a probability of consumer purchase of an item based on price and prior consumer purchasing history. With behavior prediction tool 246, creative media engine 232 may be able to predict incremental effects in purchasing incidence, revenue, and profit, of selected components in digital payload 225-2. A channel selection tool 248 is configured to select a redemption channel to the user for the offers coupons and added value certificates included in digital payload 225-2. For example, when server 230 detects that the consumer is stationary at a residential address, channel selection tool 248 may select an online channel for the consumer to redeem an offer or coupon. And when server 230 detects that the consumer is browsing through the shelves at a retail store, channel selection tool 248 may select a POS printer as a redemption channel for the consumer.

In some embodiments, targeting imputation tool 242, consumer preference tool 244, behavior prediction tool 246, and channel selection tool 248 may include a neural network model, or any nonlinear or linear regression algorithm to perform data correlations and to associate values to and ascertaining a distance measure between semantic concepts and textual descriptions such as consumer attributes and branded product attributes, purchasing probabilities, and confidence levels.

Application layer 215 produces the output of creative media engine 232 in the form of data payload 225-2 including advertisement payloads, coupons, offers, and the like, through different media channels to consumers. In some embodiments, creative media engine 232 may retrieve raw data with consumer purchasing history, product sales history, or retail store sales history, from database 252. In yet other embodiments, creative media engine 232 may retrieve raw data from a server 230 in a retail store, or retailer media network, or a server 230 hosted by a brand manufacturer.

In one or more implementations, database 252 may include a list of frequent consumers of the retailer. The consumers may have a frequent shopper identification associated with a retailer. In some embodiments, in addition to one or more “brick and mortar” physical locations of stores for the retailer, the retailer may host an online shopping outlet hosted by a network server (e.g., server 230). Server 230 may create, update, and maintain database 252, including frequent shopper identifications and purchase history logs. In that regard, database 252 may be hosted by the retailer or a brand manufacturer, while creative media engine 232 may be hosted by a DSP server or a dynamic creative rendering server. Accordingly, the DSP server may have access to one or more databases 252, through business agreements with one or more retailers or product manufacturers. In certain aspects, processor 212-2 in a server 230 hosted by a retailer may be configured to determine data for database 252 by obtaining consumer purchasing data identifying the consumer via the frequent shopper identification used at multiple purchasing events in multiple locations, over a pre-selected span of time. Processors 212-1 and 212-2, and memories 220-1 and 220-2, will be collectively referred to, hereinafter, as “processors 212” and “memories 220,” respectively.

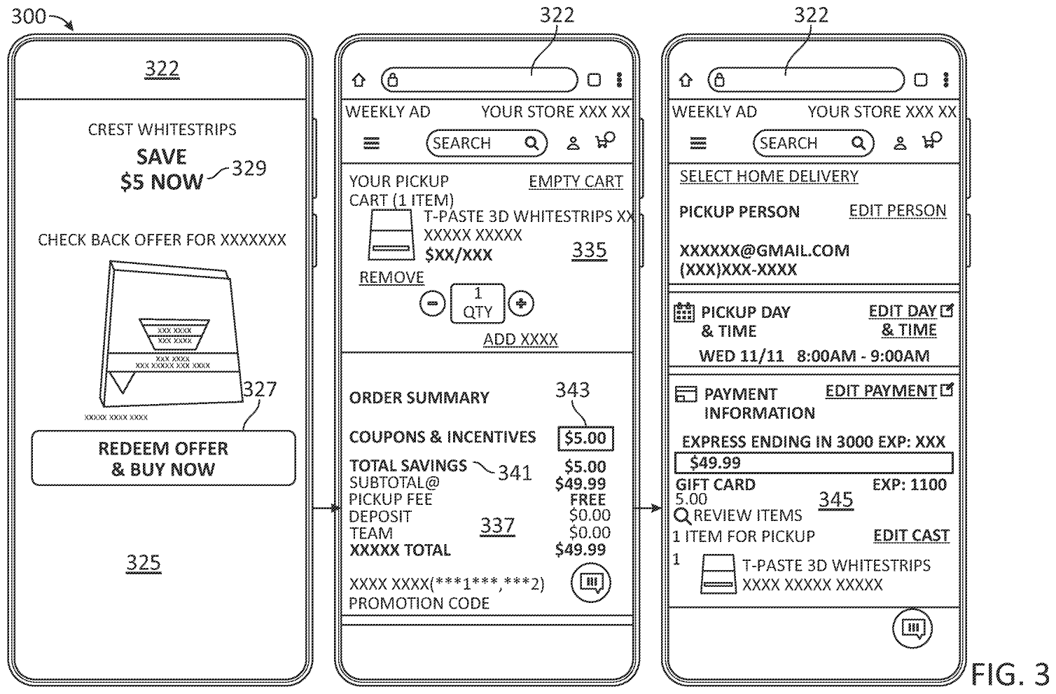

FIG. 3 is an online channel 300 for redeeming an incentive 325, according to some embodiments. The consumer receives an offer 325 for a product redeemable upon online purchase of the product. The system detects that the consumer has accessed a retailer website or application 322, or is using an e-commerce service to purchase items from a retailer or other online service, in a shopping cart. A button 327 specifies “redeem offer and buy now,” prompting the consumer to press the button. Upon button 327, the consumer is automatically taken to a checkout form 335 including a shopping basket 337 listing product 341, a price 343, and an applied offer 329 (e.g., a coupon, discount, or any other value-added transaction). Checkout form 335 then takes the consumer to an online payment service 345, for payment and completing the transaction.

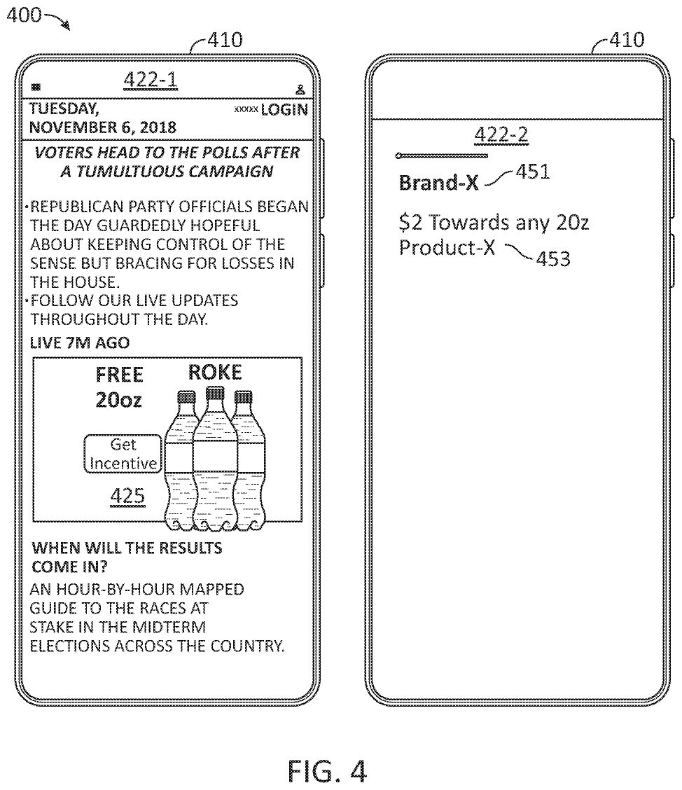

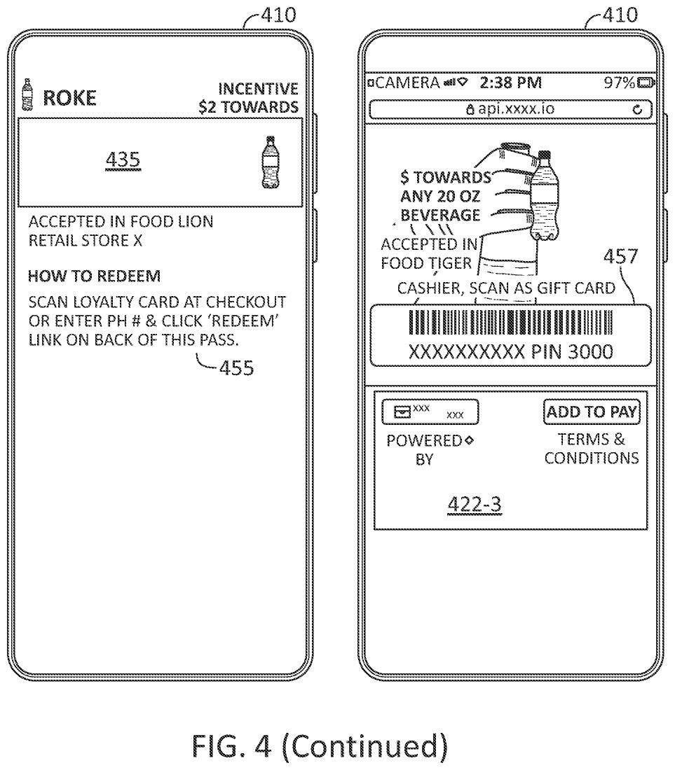

FIG. 4 illustrates an in-store channel 400 for redeeming an incentive, according to some embodiments. The system detects, via a location application running in mobile device 410, that the consumer is inside a retailer store and is therefore ready to redeem a targeted offer 425 in the store, e.g., at a kiosk or a point-of-sale (POS), and the like. The system provides in the display of the mobile device 410 an indication of the targeted offer 425 within a publishing application 422-1 being displayed for the consumer. Upon clicking targeted offer 425 by the consumer, an application 422-2 displays a list of instructions 435 for the user to redeem the targeted offer for a product. The product may be associated with a brand 451, and the offer may include a price cut 453 on the product. In some embodiments, instructions 435 may include a text 455 to scan a loyalty card, enter a phone number, and click a redeem button. In some embodiments, application 422-2 may display a digital code 457 (e.g., a bar code, a QR code, and the like), for the consumer to scan at a store kiosk or a POS. In some embodiments, text 455 may indicate to the consumer where to print and pick up the targeted offer (e.g., a coupon) from a printer at the store, and to present the coupon or printout to a cashier or scanner device at a POS. In addition to barcode 457, a payment application 422-3 may be displayed, allowing the consumer to skip a line at the POS. In some embodiments, instructions 435 may include an option for the consumer to save the offer or coupon in a digital wallet, for later use (including an expiration date for the offer).

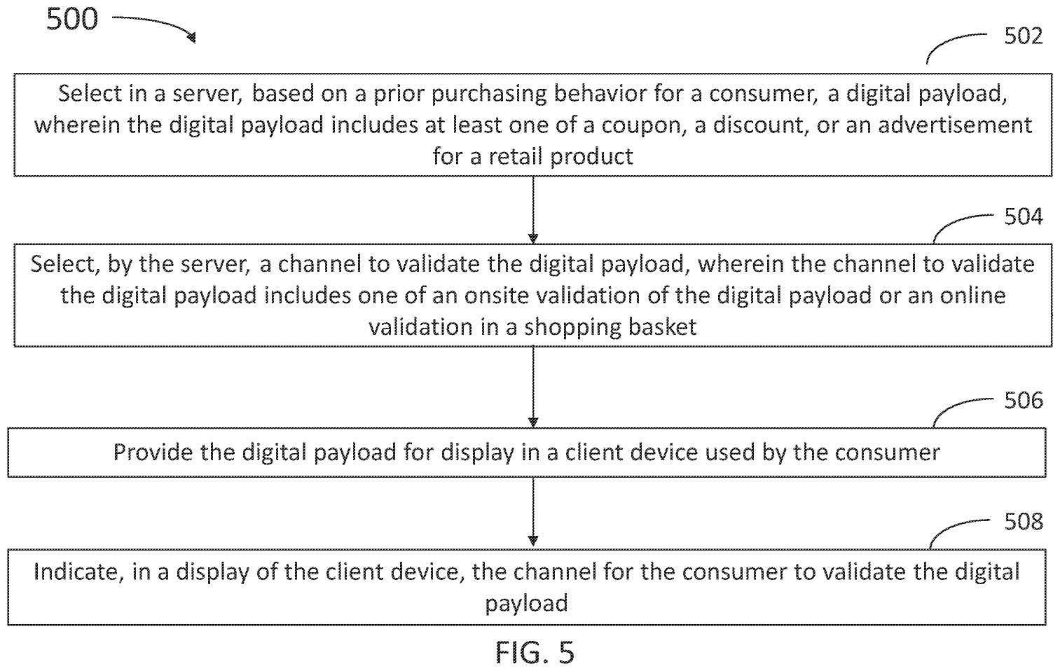

FIG. 5 is a flow chart illustrating steps in a method 500 for accessing multiple, personalized digital offers for a consumer and redeeming such offers using a single digital code, according to some embodiments. Embodiments as disclosed herein may include steps in method 500 at least partially performed by computers, servers, client devices, and databases communicatively coupled with each other via a network, as disclosed herein (e.g., client devices 110 and 210, servers 130 and 230, databases 152 and 252, and networks 150 and 250). In some embodiments, one or more steps in method 500 may be at least partially performed by a creative media engine running a targeting imputation tool, a consumer preference tool, a behavior prediction tool, or a channel selection tool, as disclosed herein (cf. targeting imputation tool 242, consumer preference tool 244, behavior prediction tool 246, and channel selection tool 248). In some embodiments, a method consistent with the present disclosure may include at least one or two of the steps in method 500 performed in any order, simultaneously, quasi-simultaneously, or overlapping in time.

Step 502 includes selecting in a server, based on a prior purchasing behavior for the consumer, a digital payload (e.g., targeted offer), wherein the digital payload includes at least one of a coupon, a discount, or an advertisement for a retail product.

Step 504 includes selecting, by the server, a channel to validate the digital payload (e.g., redeem the targeted offer), wherein the channel to validate the digital payload includes one of an onsite validation of the digital payload or an online validation in a shopping basket. In some embodiments, step 504 includes evaluating an environmental factor biasing the consumer to either one of the online redemption or the in-store redemption of the targeted offer. In some embodiments, step 504 includes evaluating a technographical data for the consumer, the technographical data including a hardware and software setting of a client device used by the consumer to download the targeted offer. In some embodiments, step 504 includes evaluating a psychographic data for the consumer, the psychographic data obtained from an online survey answered by the consumer. In some embodiments, step 504 includes evaluating a sentiment analysis about the consumer from a social network interaction of the consumer. In some embodiments, step 504 includes selecting a product and a value added to the targeted offer based on a likelihood that the consumer will purchase the product via the channel for the consumer to redeem the targeted offer. In some embodiments, step 504 includes determining a likelihood that the consumer will activate the targeted offer via the in-store redemption or the online redemption.

Step 506 includes providing the digital payload for display in a client device used by the consumer. In some embodiments, step 506 includes providing a button in the display for the consumer to automatically apply the digital payload or targeted offer to the shopping basket when the channel for the consumer to redeem the targeted offer is an online redemption channel.

Step 508 includes indicating, in a display of the client device, the channel for the consumer to validate the digital payload (e.g., redeem the targeted offer). In some embodiments, step 508 includes providing a digital code in the display for the consumer to scan the digital code at a point of sale of a retailer store. In some embodiments, step 508 includes directing the client device to communicate with a printer at a retailer store to print the targeted offer when the channel for the consumer to redeem the targeted offer is an in-store channel.

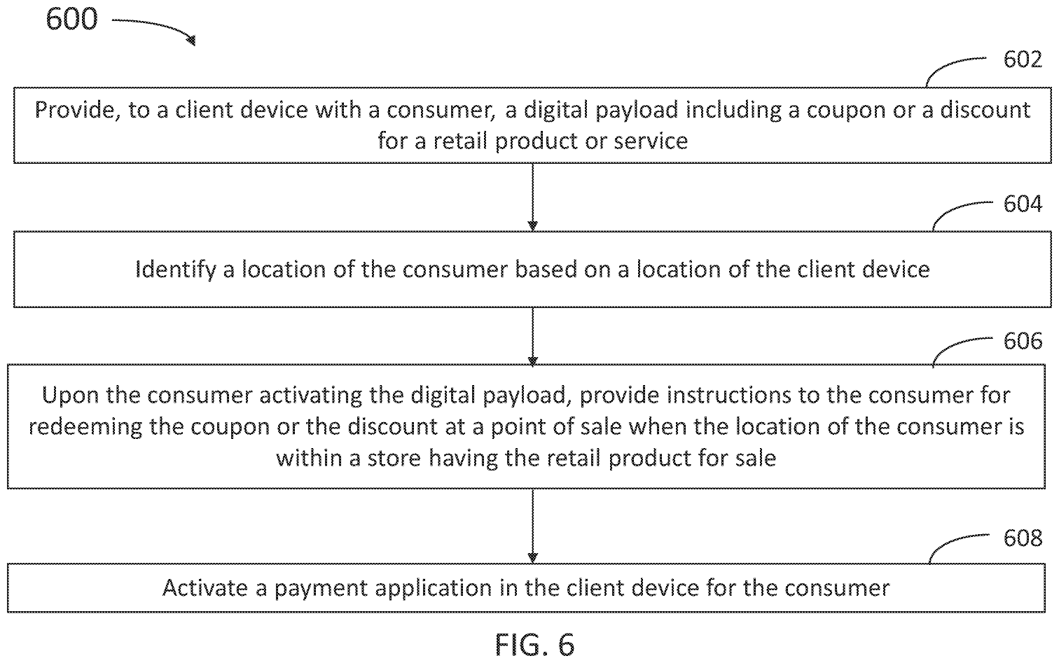

FIG. 6 is a flow chart illustrating steps in a method 600 for generating a creative media including a personalized offer for a user, according to some embodiments. Embodiments as disclosed herein may include steps in method 600 at least partially performed by computers, servers, client devices, and databases communicatively coupled with each other via a network, as disclosed herein (e.g., client devices 110 and 210, servers 130 and 230, databases 152 and 252, and networks 150 and 250). In some embodiments, one or more steps in method 600 may be at least partially performed by a creative media engine running a targeting imputation tool, a consumer preference tool, a behavior prediction tool, or a channel selection tool, as disclosed herein (cf. targeting imputation tool 242, consumer preference tool 244, behavior prediction tool 246, and channel selection tool 248). In some embodiments, a method consistent with the present disclosure may include at least one or two of the steps in method 600 performed in any order, simultaneously, quasi-simultaneously, or overlapping in time.

Step 602 includes providing, to a client device with a consumer, a digital payload including a coupon or a discount for a retail product or service. In some embodiments, step 602 includes bidding for the digital payload with a supply side provider server hosting a publishing application loaded on the client device.

Step 604 includes identifying a location of the consumer based on a location of the client device. In some embodiments, step 604 includes accessing a mobile location data from the client device.

Step 606 includes, upon the consumer activating the digital payload, providing instructions to the consumer for redeeming the coupon or the discount at a point of sale when the location of the consumer is within a store having the retail product for sale.

Step 608 includes activating a payment application in the client device for the consumer. In some embodiments, step 608 further includes redeeming online the coupon or the discount, when the location of the consumer is within a residential area. In some embodiments, step 608 further includes logging the client device into a retail media network that carries the retail product.

### Hardware Overview

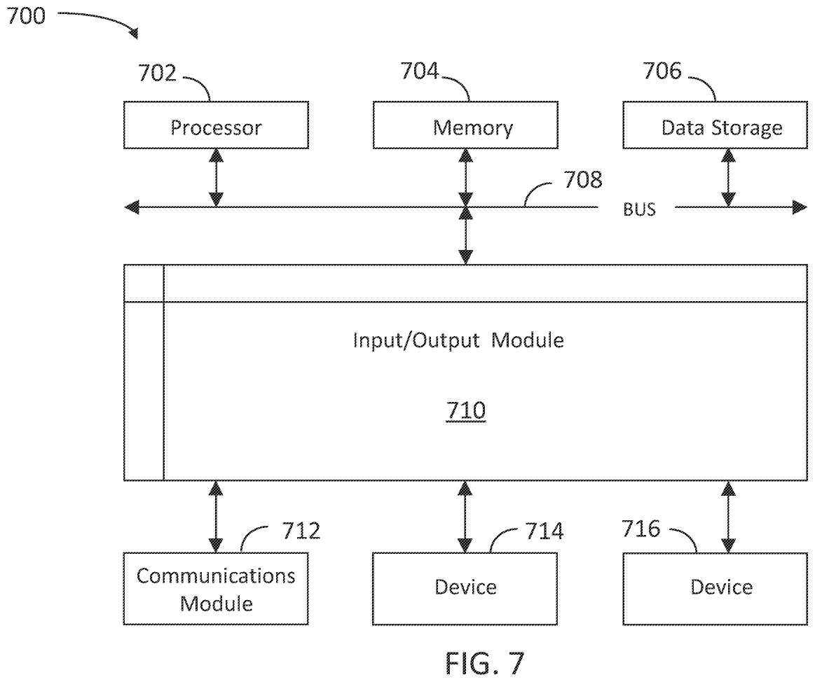

FIG. 7 is a block diagram illustrating an exemplary computer system 700 with which the client device 110 and server 130 of FIGS. 1 and 2, and the methods of FIGS. 5 and 6 can be implemented. In certain aspects, the computer system 700 may be implemented using hardware or a combination of software and hardware, either in a dedicated server, or integrated into another entity, or distributed across multiple entities.

Computer system 700 (e.g., client device 110 and server 130) includes a bus 708 or other communication mechanism for communicating information, and a processor 702 (e.g., processors 212) coupled with bus 708 for processing information. By way of example, the computer system 700 may be implemented with one or more processors 702. Processor 702 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 700 can include, in addition to hardware, code that creates an execution environment for the computer program in question, e.g., code that constitutes processor firmware, a protocol stack, a database management system, an operating system, or a combination of one or more of them stored in an included memory 704 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled with bus 708 for storing information and instructions to be executed by processor 702. The processor 702 and the memory 704 can be supplemented by, or incorporated in, special purpose logic circuitry.

The instructions may be stored in the memory 704 and implemented in one or more computer program products, e.g., one or more modules of computer program instructions encoded on a computer-readable medium for execution by, or to control the operation of, the computer system 700, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PRP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 704 may also be used for storing temporary variable or other intermediate information during execution of instructions to be executed by processor 702.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and inter-coupled by a communication network. The processes and logic flows described in this specification can be performed by one or more programmable processors executing one or more computer programs to perform functions by operating on input data and generating output.

Computer system 700 further includes a data storage device 706 such as a magnetic disk or optical disk, coupled with bus 708 for storing information and instructions. Computer system 700 may be coupled via input/output module 710 to various devices. Input/output module 710 can be any input/output module. Exemplary input/output modules 710 include data ports such as USB ports. The input/output module 710 is configured to connect to a communications module 712. Exemplary communications modules 712 (e.g., communications modules 218) include networking interface cards, such as Ethernet cards and modems. In certain aspects, input/output module 710 is configured to connect to a plurality of devices, such as an input device 714 (e.g., input device 214) and/or an output device 716 (e.g., output device 216). Exemplary input devices 714 include a keyboard and a pointing device, e.g., a mouse or a trackball, by which a consumer can provide input to the computer system 700. Other kinds of input devices 714 can be used to provide for interaction with a consumer as well, such as a tactile input device, visual input device, audio input device, or brain-computer interface device. For example, feedback provided to the consumer can be any form of sensory feedback, e.g., visual feedback, auditory feedback, or tactile feedback; and input from the consumer can be received in any form, including acoustic, speech, tactile, or brain wave input. Exemplary output devices 716 include display devices, such as an LCD (liquid crystal display) monitor, for displaying information to the consumer.

According to one aspect of the present disclosure, the client device 110 and server 130 can be implemented using a computer system 700 in response to processor 702 executing one or more sequences of one or more instructions contained in memory 704. Such instructions may be read into memory 704 from another machine-readable medium, such as data storage device 706. Execution of the sequences of instructions contained in main memory 704 causes processor 702 to perform the process steps described herein. One or more processors in a multi-processing arrangement may also be employed to execute the sequences of instructions contained in memory 704. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data server, or that includes a middleware component, e.g., an application server, or that includes a front end component, e.g., a client computer having a graphical consumer interface or a Web browser through which a consumer can interact with an implementation of the subject matter described in this specification, or any combination of one or more such back end, middleware, or front end components. The components of the system can be inter-coupled by any form or medium of digital data communication, e.g., a communication network. The communication network (e.g., networks 150 and 250) can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 700 can include clients and servers. A client and server are generally remote from each other and typically interact through a communication network. The relationship of client and server arises by virtue of computer programs running on the respective computers and having a client-server relationship to each other. Computer system 700 can be, for example, and without limitation, a desktop computer, laptop computer, or tablet computer. Computer system 700 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 702 for execution. Such a medium may take many forms, including, but not limited to, non-volatile media, volatile media, and transmission media. Non-volatile media include, for example, optical or magnetic disks, such as data storage device 706. Volatile media include dynamic memory, such as memory 704. Transmission media include coaxial cables, copper wire, and fiber optics, including the wires forming bus 708. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

In one aspect, a method may be an operation, an instruction, or a function and vice versa. In one aspect, a clause may be amended to include some or all of the words (e.g., instructions, operations, functions, or components) recited in other one or more clauses, one or more words, one or more sentences, one or more phrases, one or more paragraphs, and/or one or more clauses.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described as such, one or more features from a described combination can in some cases be excised from the combination, and the described combination may be directed to a subcombination or variation of a subcombination.

The subject matter of this specification has been described in terms of particular aspects, but other aspects can be implemented and are within the scope of the following clauses. For example, while operations are depicted in the drawings in a particular order, this should not be understood as requiring that such operations be performed in the particular order shown or in sequential order, or that all illustrated operations be performed, to achieve desirable results. The actions recited in the clauses can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the clauses. In addition, in the detailed description, it can be seen that the description provides illustrative examples and the various features are grouped together in various implementations for the purpose of streamlining the disclosure. The method of disclosure is not to be interpreted as reflecting an intention that the described subject matter requires more features than are expressly recited in each clause. Rather, as the clauses reflect, inventive subject matter lies in less than all features of a single disclosed configuration or operation. The clauses are hereby incorporated into the detailed description, with each clause standing on its own as a separately described subject matter.

The clauses are not intended to be limited to the aspects described herein, but are to be accorded the full scope consistent with the language clauses and to encompass all legal equivalents. Notwithstanding, none of the clauses are intended to embrace subject matter that fails to satisfy the requirements of the applicable patent law, nor should they be interpreted in such a way.

### Recitation of Embodiments

The subject technology is illustrated, for example, according to various aspects described below. Various examples of aspects of the subject technology are described as Embodiment I, II, and III, for convenience. These are provided as examples, and do not limit the subject technology.

Embodiment I: A computer-implemented method includes selecting in a server, based on a prior purchasing behavior for a consumer, a targeted offer, wherein the targeted offer includes at least one of a coupon, a discount, or an advertisement for a retail product. The computer-implemented method also includes selecting, by the server, a channel for the consumer to redeem the targeted offer, wherein the channel for the consumer to redeem the targeted offer includes one of an in-store redemption of the targeted offer or an online redemption in a shopping basket, providing the targeted offer for display in a client device used by the consumer, and indicating, in the display, the channel for the consumer to redeem the targeted offer.

Embodiment II: A system, including one or more processors configured to execute multiple instructions; and a memory storing the instructions that cause the one or more processors to cause the system to perform operations. The operations include to: select, based on a prior purchasing behavior for a consumer, a targeted offer, wherein the targeted offer includes at least one of a coupon, a discount, or an advertisement for a retail product, to select a channel for the consumer to redeem the targeted offer, wherein the channel for the consumer to redeem the targeted offer includes one of an in-store redemption of the targeted offer or an online redemption in a shopping basket, to provide the targeted offer for display in a client device used by the consumer, and to indicate, in the display, the channel for the consumer to redeem the targeted offer.

Embodiment III: A computer-implemented method includes providing, to a client device with a consumer, a digital payload including a coupon or a discount for a retail product or service, identifying a location of the consumer based on a location of the client device, upon the consumer activating the digital payload, providing instructions to the consumer for redeeming the coupon or the discount at a point of sale when the location of the consumer is within a store having the retail product for sale, and activating a payment application in the client device for the consumer.

In some embodiments, the features of Embodiments I, II, and III may be combined with any one or more of the below elements, wherein:

Element 1, wherein selecting by the server a channel for the consumer includes evaluating an environmental factor biasing the consumer to either one of the online redemption or the in-store redemption of the targeted offer. Element 2, wherein selecting by the server a channel for the consumer includes evaluating a technographical data for the consumer, the technographical data including a hardware and software setting of a client device used by the consumer to download the targeted offer. Element 3, wherein selecting by the server a channel for the consumer includes evaluating a psychographic data for the consumer, the psychographic data obtained from an online survey answered by the consumer. Element 4, wherein selecting by the server a channel for the consumer includes evaluating a sentiment analysis about the consumer from a social network interaction of the consumer. Element 5, wherein selecting in the server a targeted offer to the consumer includes selecting a product and a value added to the targeted offer based on a likelihood that the consumer will purchase the product via the channel for the consumer to redeem the targeted offer. Element 6, wherein selecting by the server the channel to redeem the targeted offer includes determining a likelihood that the consumer will activate the targeted offer via the in-store redemption or the online redemption. Element 7, wherein providing the targeted offer for display in the client device used by the consumer includes providing a button in the display for the consumer to automatically apply the targeted offer to the shopping basket when the channel for the consumer to redeem the targeted offer is an online redemption channel. Element 8, wherein indicating the channel for the consumer to redeem the targeted offer includes providing a digital code in the display for the consumer to scan the digital code at a point of sale of a retailer store. Element 9, further including directing the client device to communicate with a printer at a retailer store to print the targeted offer when the channel for the consumer to redeem the targeted offer is an in-store channel.

Element 10, wherein to select a channel for the consumer the one or more processors execute instructions to evaluate an environmental factor biasing the consumer to either one of the online redemption or the in-store redemption of the targeted offer. Element 11, wherein to select a channel for the consumer the one or more processors execute instructions to evaluate a technographical data for the consumer, the technographical data including a hardware and software setting of a client device used by the consumer to download the targeted offer. Element 12, wherein to select a channel for the consumer the one or more processors execute instructions to evaluate a psychographic data for the consumer, the psychographic data obtained from an online survey answered by the consumer. Element 13, wherein to select a channel for the consumer the one or more processors execute instructions to evaluate a sentiment analysis about the consumer from a social network interaction of the consumer.

Element 14, wherein providing a digital payload includes bidding for the digital payload with a supply side provider server hosting a publishing application loaded on the client device. Element 15, wherein identifying a location of the consumer includes accessing a mobile location data from the client device. Element 16, further including redeeming online the coupon or the discount, when the location of the consumer is within a residential area. Element 17, further including logging the client device into a retail media network that carries the retail product.

1. A computer-implemented method, comprising:
selecting, based on a prior purchasing behavior for a consumer, a digital payload, wherein the digital payload comprises at least one of a coupon, a discount, or an advertisement for a retail product;
selecting a channel for the consumer to validate the digital payload, wherein the channel for the consumer to validate the digital payload comprises one of an onsite validation of the digital payload or an online validation in a shopping basket;
providing the digital payload for display in a client device used by the consumer; and
indicating, in the display, the channel for the consumer to redeem the digital payload.

2. The computer-implemented method of claim 1, wherein selecting a channel for the consumer comprises evaluating an environmental factor biasing the consumer to either one of the online validation or the onsite validation of the digital payload.

3. The computer-implemented method of claim 1, wherein selecting a channel for the consumer comprises evaluating a technographical data for the consumer, the technographical data comprising a hardware and software setting of a client device used by the consumer to download the digital payload.

4. The computer-implemented method of claim 1, wherein selecting a channel for the consumer comprises evaluating a psychographic data for the consumer, the psychographic data obtained from an online survey answered by the consumer.

5. The computer-implemented method of claim 1, wherein selecting a channel for the consumer comprises evaluating a sentiment analysis about the consumer from a social network interaction of the consumer.

6. The computer-implemented method of claim 1, wherein selecting a digital payload to the consumer comprises selecting a product and a value added to the digital payload based on a likelihood of a consumer purchase of the product via the channel for the consumer to redeem the digital payload.

7. The computer-implemented method of claim 1, wherein selecting the channel to redeem the digital payload comprises determining a likelihood that the consumer will activate the digital payload via the onsite validation or the online validation.

8. The computer-implemented method of claim 1, wherein providing the digital payload for display in the client device used by the consumer comprises providing a button in the display for the consumer to automatically apply the digital payload to the shopping basket when the channel for the consumer to redeem the digital payload is an online redemption channel.

9. The computer-implemented method of claim 1, wherein indicating the channel for the consumer to redeem the digital payload comprises providing a digital code in the display for the consumer to scan the digital code at a point of sale of a retailer store.

10. The computer-implemented method of claim 1, further comprising directing the client device to communicate with a printer at a retailer store to print the digital payload when the channel for the consumer to redeem the digital payload is an in-store channel.

11. A system, comprising:
one or more processors configured to execute multiple instructions; and
a memory storing the instructions that cause the one or more processors to cause the system to perform operations, comprising to:
select, based on a prior purchasing behavior for a consumer, a digital payload, wherein the digital payload comprises at least one of a coupon, a discount, or an advertisement for a retail product;
select a channel for the consumer to validate the digital payload, wherein the channel for the consumer to validate the digital payload comprises one of an onsite validation of the digital payload or an online validation in a shopping basket;
provide the digital payload for display in a client device used by the consumer; and
indicate, in the display, the channel for the consumer to redeem the digital payload.

12. The system of claim 11, wherein to select a channel for the consumer the one or more processors execute instructions to evaluate an environmental factor biasing the consumer to either one of the online validation or the onsite validation of the digital payload.

13. The system of claim 11, wherein to select a channel for the consumer the one or more processors execute instructions to evaluate a technographical data for the consumer, the technographical data comprising a hardware and software setting of a client device used by the consumer to download the digital payload.

14. The system of claim 11, wherein to select a channel for the consumer the one or more processors execute instructions to evaluate a psychographic data for the consumer, the psychographic data obtained from an online survey answered by the consumer.

15. The system of claim 11, wherein to select a channel for the consumer the one or more processors execute instructions to evaluate a sentiment analysis about the consumer from a social network interaction of the consumer.

16. A computer-implemented method, comprising:
providing, to a client device with a consumer, a digital payload including a coupon or a discount for a retail product or service;
identifying a location of the consumer based on a location of the client device;
upon the consumer activating the digital payload, providing instructions to the consumer for redeeming the coupon or the discount at a point of sale when the location of the consumer is within a store having the retail product for sale; and
activating a payment application in the client device for the consumer.

17. The computer-implemented method of claim 16, wherein providing a digital payload comprises bidding for the digital payload with a supply side provider server hosting a publishing application loaded on the client device.

18. The computer-implemented method of claim 16, wherein identifying a location of the consumer comprises accessing a mobile location data from the client device.

19. The computer-implemented method of claim 16, further comprising redeeming online the coupon or the discount, when the location of the consumer is within a residential area.

20. The computer-implemented method of claim 16, further comprising logging the client device into a retail media network that carries the retail product.
